(19) United States
(12) Patent Application Publication
(10) Pub. No.: US 2025/0128382 A1
(43) Pub. Date: Apr. 24, 2025

(54) Adjustable Clamp

(71) Applicant: Videndum Production Solutions Inc., Shelton, CT (US)

(72) Inventors: David Pasko, Middlebury, CT (US); Bo Christensen, Nordborg (DK); Michael Herbert, London (GB); Charles M. Smallwood, North Hollywood, CA (US)

(21) Appl. No.: 18/924,459

(22) Filed: Oct. 23, 2024

Related U.S. Application Data
(60) Provisional application No. 63/592,775, filed on Oct. 24, 2023.

(51) Int. Cl. B25B 5/10

(52) U.S. Cl. CPC B25B 5/102

(57) ABSTRACT

A clamp includes a frame, a first jaw coupled to the frame and fixed in position relative thereto, and a second jaw coupled to the frame opposite the first jaw and slidable relative to the frame. A stem extends at least partially through a stem aperture in the frame and engages with the second jaw. The stem is translatable relative to the frame along a stem axis and rotatable about the stem axis. A stem head is coupled to the stem, and the stem aperture is sized to prevent the stem head from passing entirely therethrough. A biasing element biases the second jaw towards the first jaw, and the second jaw is capable of translating relative to the frame along the stem axis in response to translation of the stem without rotating about the stem axis.

### CROSS-REFERENCE TO RELATED APPLICATIONS

This application claims the benefit of U.S. Provisional Patent Application No. 63/592,775 filed Oct. 24, 2023 entitled “Adjustable Clamp”, which is incorporated by reference herein in its entirety.

### TECHNICAL FIELD

The present disclosure generally relates to fastening devices and, in some embodiments, to an adjustable clamp for mounting accessories thereto.

### SUMMARY

In one embodiment there is a clamp including a frame, a first jaw coupled to the frame and fixed in position relative to the frame, a second jaw coupled to the frame opposite the first jaw and slidable relative to the frame, a stem extending at least partially through a stem aperture in the frame and engaged with the second jaw, the stem translatable relative to the frame along a stem axis and rotatable about the stem axis, a stem head coupled to the stem, the stem aperture being sized to prevent the stem head from passing entirely therethrough, and a biasing element biasing the second jaw towards the first jaw, the second jaw being capable of translating relative to the frame along the stem axis in response to translation of the stem without rotating about the stem axis.

In some embodiments, the first jaw and second jaw each include inner surfaces facing towards one another and having generally the same radius of curvature. In some embodiments, the first jaw and second jaw when in a closed position form an arc. In some embodiments, the first jaw and second jaw extend upwardly from the frame and terminate at ends that are spaced from one another. In some embodiments, when in the closed position the ends of each of the first jaw and second jar do not directly contact one another. In some embodiments, the first jaw and second jaw each extends at least partially along a length of the frame in a direction transverse to the stem axis.

In some embodiments, translation of the stem head along the stem axis towards the stem aperture causes the biasing element to compress. In some embodiments, rotation of the stem head about the stem axis does not cause the biasing element to compress. In some embodiments, the first jaw is a first fixed jaw and the second jaw is an adjustable jaw, the clamp further includes, a second fixed jaw coupled to the frame and fixed in position relative to the frame, the second fixed jaw being positioned opposite the adjustable jaw on the same side of the frame as the first fixed jaw. In some embodiments, the first fixed jaw, the adjustable jaw, and the second fixed jaw are positioned along a top surface of the frame and arranged in a serpentine pattern.

In some embodiments the clamp further includes a pin coupled to the second jaw and extending through a pin aperture of the frame, the pin aperture extending through a side surface of the frame opposite the stem aperture, the pin being translatable along the pin aperture in a direction generally parallel to the stem axis. In some embodiments, the second jaw has a maximum travel distance defined at least partially by the stem head and rotation of the stem about the stem axis causes the maximum travel distance of the second jaw to be altered. In some embodiments, the stem head is connected to the stem at a proximal receiving segment thereof and the stem is connected to the second jaw at a distal receiving segment thereof. In some embodiments, the stem is at least partially threaded and is threadably coupled to the second jaw.

In some embodiments, the distal receiving segment of the stem is threaded and the stem further includes a non-threaded intermediary segment between the proximal and distal receiving segments that is slidable along the stem aperture. In some embodiments, the frame includes a channel constraining movement of the second jaw relative to the frame in at least one direction. In some embodiments, the stem head is a knob having an outer diameter greater than an outer diameter of the stem aperture.

In another embodiment there is a clamp including a frame, a first jaw fixedly coupled to the frame, a second jaw adjustably coupled to the frame, the second jaw being slidable toward or away from the first jaw along a linear axis, a stem extending along the linear axis and through an aperture in the frame, the stem attached to the second jaw at a distal portion and attached to a stem head at a proximal portion, a distance between the stem head and second jaw capable of being adjusted to limit travel of the second jaw along the linear axis, and a biasing element biasing the second jaw towards the first jaw. Movement of the stem head along the linear axis may cause the second jaw to translate along the linear axis with the stem head and wherein rotation of the stem head about the linear axis causes a distance between the stem head and second jaw to be adjusted. In some embodiments, the second jaw capable of translating relative to the frame along the stem axis without rotating about the stem axis.

In another embodiment there is a clamp including a frame having a top surface and a channel open at the top surface and extending partially toward a bottom surface of the frame, the frame including a stem aperture extending from a side surface of the frame to the channel, a first jaw fixedly coupled to the frame and extending upwardly from the top surface thereof, a second jaw coupled to a slide received within the channel, the second jaw extending outwardly from the top surface of the frame, the second jaw slidable relative to the first jaw along a linear axis, a biasing element engaged with the slide and biasing the second jaw towards the first jaw in a direction generally parallel to the linear axis, a stem extending through the stem aperture along the linear axis and having a threaded distal portion engaged with the slide and a proximal portion attached to a knob. Movement of the knob along the linear axis causes the second jaw to translate along the linear axis with the knob and wherein rotation of the knob about the linear axis causes a distance between the knob and second jaw to be adjusted, and the second jaw is capable of translating relative to the frame along the stem axis without rotating about the stem axis.

### BRIEF DESCRIPTION OF THE DRAWINGS

The following detailed description of embodiments of the adjustable clamp, will be better understood when read in conjunction with the appended drawings of exemplary embodiments. It should be understood, however, that the invention is not limited to the precise arrangements and instrumentalities shown.

In the drawings:

FIG. 1 is a top perspective view of an adjustable clamp in accordance with an exemplary embodiment of the present disclosure and;

FIG. 2 is a bottom perspective view of the adjustable clamp of FIG. 1;

FIG. 3 is a left-side elevational view of the adjustable clamp of FIG. 1;

FIG. 4 is a front elevational view of the adjustable clamp of FIG. 1;

FIG. 5 is a rear perspective view of the adjustable clamp of FIG. 1;

FIG. 6 is a cross-sectional view of the adjustable clamp of FIG. 1;

FIG. 7 is a top elevational view of the adjustable clamp of FIG. 1;

FIG. 8 is a side elevational view of the adjustable clamp of FIG. 1 in a closed position;

FIG. 9 is a side elevational view of the adjustable clamp of FIG. 8 in an open position;

FIG. 10 is a top, rear perspective view of the adjustable clamp of FIG. 1;

FIG. 11 is a side elevational view of the adjustable clamp of FIG. 1 in a closed position;

FIG. 12 is a side elevational view of the adjustable clamp of FIG. 11 in the closed position following adjustment of the position of the stem head; and

FIG. 13 is a side elevational view of the adjustable clamp of FIG. 12 in an open position following the adjustment of the position of the stem head.

### DETAILED DESCRIPTION

Fastening devices such as clamps are often used for securing objects (e.g., accessories, structures) to one another. Conventional clamps include opposed jaws aligned with one another and operable to apply a pressure on objects positioned therebetween. However, opening, closing, loosening and/or tightening of the opposed jaws typically requires the use of both hands resulting in conventional clamps being cumbersome to use. For example, when clamping a light source to a vertical support beam or truss a user typically must use one hand to retain the light source at a desired location while using the remaining hand to operate the jaws of the clamp, which is very difficult and cumbersome and can result in damage to the object and/or clamp (e.g., dropping one or the other). Similarly, loosening conventional clamps to make adjustments to the position of the light source received within is difficult and cumbersome for at least the same reasons. As such, there is a need to provide an adjustable clamp configured to be operable with a single hand to open, close, tighten and/or loosen the clamp on an object.

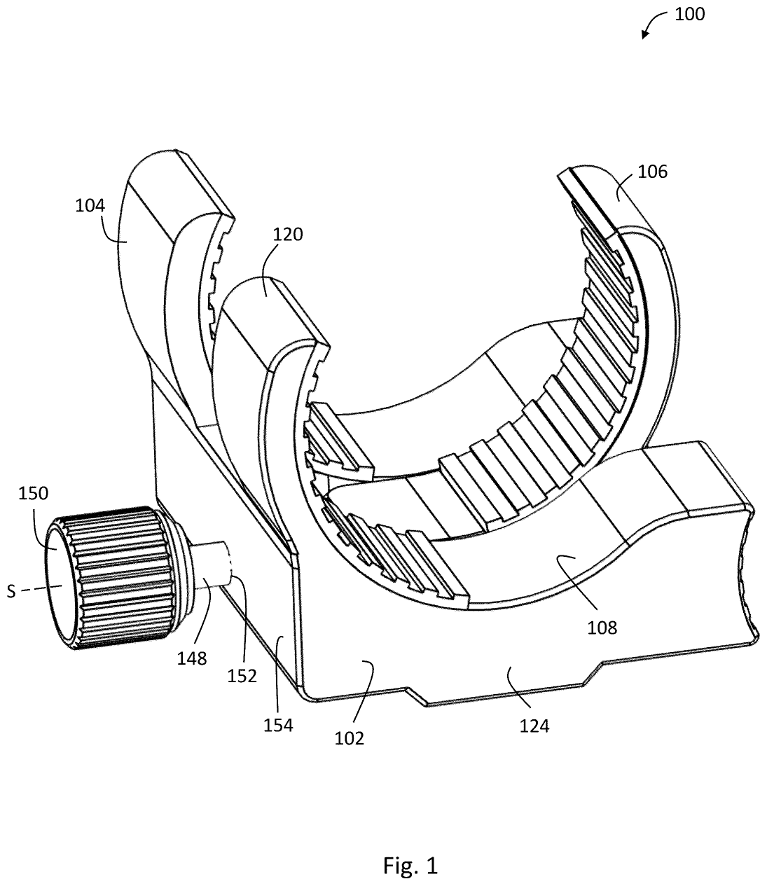

Referring to the drawings in detail, wherein like reference numerals indicate like elements throughout, there is shown in FIGS. 1-13 an adjustable clamp generally designated 100 and referred to as clamp 100 herein, in accordance with an exemplary embodiment of the present invention. In some embodiments, the clamp 100 is configured to receive an accessory (e.g., a light source, an LED tube light, a fluorescent tube light, a dimmable light source, or any other type of powered light source) therein and mount the accessory to a desired object (e.g., a lighting truss). In some embodiments, the clamp 100 is configured to be operated by a user with a single hand to open, close, tighten and/or loosen the clamp 100. In some embodiments, the clamp 100 is configured to be operated by hand without the need for or use of additional tools (e.g., hand tools, power tools).

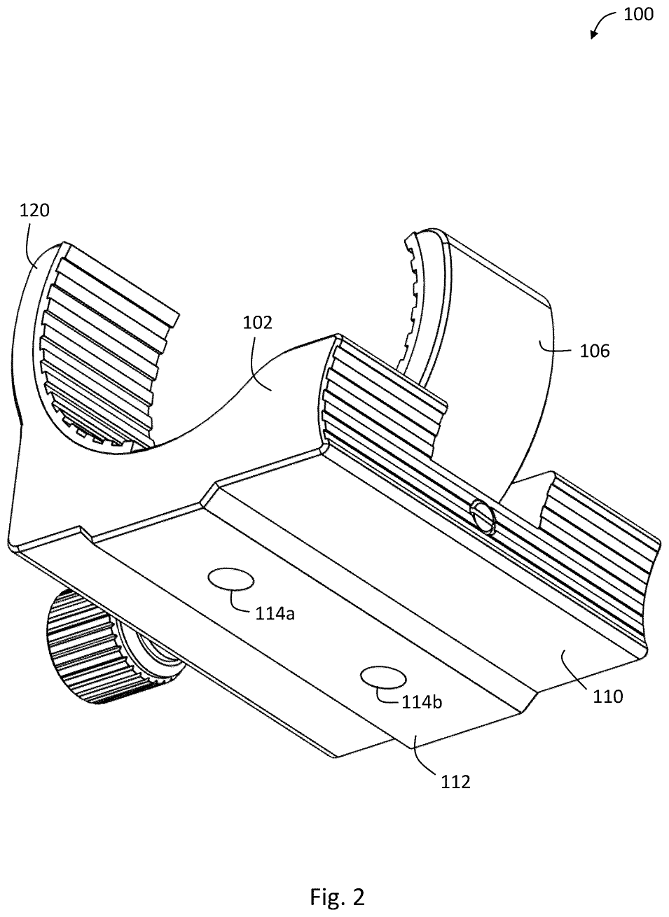

Referring to FIGS. 1-2, the clamp 100 may include a frame 102, a first jaw 104 fixed in position relative to the frame 102 and a second jaw 106 translatable relative to the frame. The jaws 104, 106 may be configured to receive an accessory (e.g., a light source, a fluorescent light bulb) therebetween to releasably couple the accessory to the clamp 100. For example, and as discussed in more detail below, the second jaw 106 may apply pressure to the accessory to retain the accessory between the jaws 104, 106. The frame 102 may be configured to act as a structural support for the elements of the clamp 100. In some embodiments, the frame 102 is a generally rigid structure that is configured to remain generally undeformed in response to pressure exerted on an object retained within the jaws 104, 106. For example, the frame 102 may be comprised of a generally rigid material (e.g., a metal, a plastic) having a modulus of elasticity sufficient to overcome forces exerted by the jaws coupled thereto. In some embodiments, the frame 102 is comprised of one or more of steel, stainless steel, aluminum, an aluminum alloy, cast iron, titanium, a titanium alloy, a plastic, and a reinforced plastic. In some embodiments, the frame 102 may be treated with a protective coating (e.g., a corrosion-resistant surface treatment) to reduce degradation of the frame 102, for example, when the clamp 100 is used outdoors and/or exposed to moisture. In some embodiments, frame 102, first and second jaws 104, 106, and/or other components of clamp 100 may be constructed from an anodized metal or alloy, e.g., anodized aluminum. In some embodiments, the frame 102 is formed via a machining method, die cast, additive manufacturing, or any other manufacturing means known to those skilled in the art.

The frame 102 may include a top surface 108 for coupling the jaws 104 thereto and a bottom surface 110 configured to couple the frame 102 to a desired object and/or structure other than the object received within the jaws 104, 106. The bottom surface 110 may include a mounting plate 112 protruding outwardly from bottom surface 110 and configured to couple the clamp 100 to a corresponding mounting feature of an object or structure. For example, the mounting plate 112 illustrated in FIG. 2 is shaped to be received within a groove or channel and includes threaded apertures 114a and 114b each sized and positioned along the mounting plate to align with corresponding fasteners (not shown). The mounting plate 112 may, however, be any shape, size, orientation and include any desired mounting features. For example, in one instance the mounting plate 112 has a shape configured to be slid along and retained within a dovetail groove (e.g., a circular shape, a trapezoidal shape). In another instance, the mounting plate 112 includes an indexed mating surface corresponding to an indexed mating feature of the object or structure to which the clamp 100 is intended to be coupled to.

For example, the mounting plate 112 may be configured to be coupled to a rail or other mounting structure, e.g., a picatinny rail. In further embodiments, the bottom surface 110 may be generally planar and may include at least one aperture (e.g., a threaded aperture) for receiving a fastener (e.g., a screw). In some embodiments, the mounting plate 112 is configured to be coupled to a surface of a truss or stand for a lighting fixture. The mounting plate 112 of the frame 102 may enable the clamp 100 to couple an accessory received between the first and second jaws 104, 106 to a desired object and/or surface (e.g., a lighting stand). The jaws 104, 106 may be configured to retain the accessory therein such that the frame 102 is at least partially sandwiched between the accessory and the mounting surface to which the mounting plate 112 is attached.

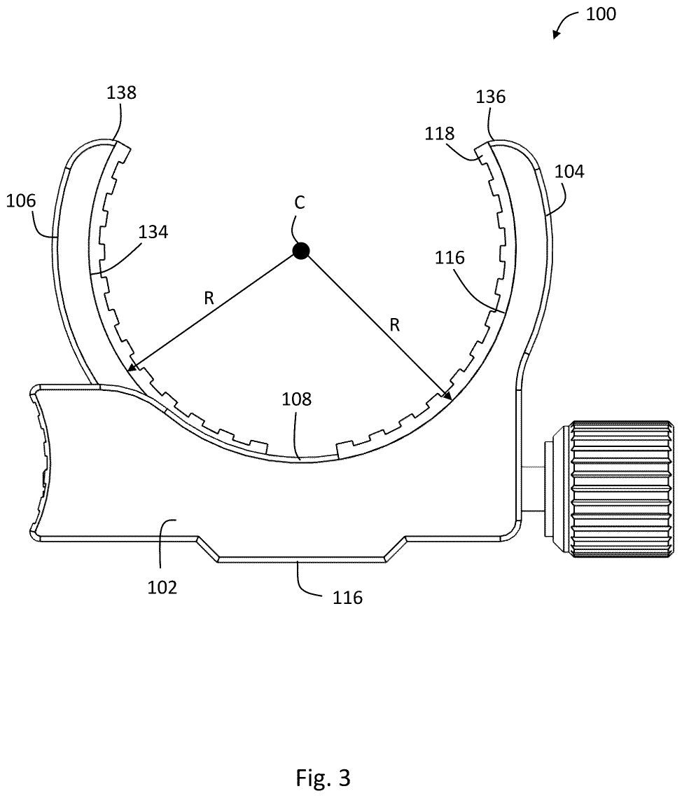

Referring to FIGS. 1 and 3, the first jaw 104 may be a first fixed jaw that is coupled to the frame 102 and fixed relative thereto. For example, the first jaw 104 may be coupled to the frame 102 and extend upwardly from the top surface 108 away from the bottom surface 110. In some embodiments, the first jaw 104 is integrally formed with the frame 102. For example, the frame 102 and first jaw 104 integrally formed together via die casting. In other embodiments, the frame 102 and first jaw 104 are formed separately and fixedly attached to one another (e.g., via welding). The first jaw 104 may have an inner surface 116 that is shaped corresponding to the shape of an accessory to be received by the first and second jaws 104, 106. For example, and as illustrated in FIG. 2, the inner surface 116 is curved (e.g., concavely curved) to generally match the curved (e.g., convexly curved) surface of an accessory (e.g., a fluorescent tube light source). In some embodiments, the inner surface 116 of the first jaw 104 is a concave cylindrical surface defined by a radius of curvature R. The radius of curvature R may be based on the radius of curvature of the corresponding accessory. For example, the radius of curvature R may be greater than or equal to the radius of curvature of a cylindrical shaped accessory (e.g., a cylindrical tube light) such that a substantial portion of the first jaw 104 abuts the outer surface of the accessory. In some embodiments, the first jaw 104 forms an arc defined by the radius of curvature R. In some embodiments, the radius of curvature R is suitable to receive a tube light source having a diameter of at least about 1.65 inches. In some embodiments, the radius of curvature R is selected from a range of about 0.65 inches to about 0.85 inches, e.g., about 0.70 inches to about 0.78 inches. In some embodiments, the radius of curvature R is about 0.75 inches. For example, in some embodiments, the radius of curvature R is selected such that first and second jaws 104, 106 will fit tightly around a T12 tube light (about 38.1 mm in diameter). In other embodiments, the radius of curvature R is selected such that first and second jaws 104, 106 will fit tightly around a T8 tube light (about 25.4 mm in diameter) or a T5 tube light (about 18.8 mm in diameter).

However, in other instances the first jaw 104 may have a different shape corresponding to the shape of accessories to be clamped between the jaws 104, 106. In one embodiment the inner surface 116 of the first jaw 104 is substantially planar. For example, the first jaw 104 may be shaped such that the inner surface 116 substantially abuts a planar surface of an accessory. In another embodiment the inner surface 116 may have a generally L-shape. For example, the inner surface 116 may be shaped to abut at least two adjoining surfaces of a generally cuboid shaped accessory.

In some embodiments, the first jaw 104 includes a gripping surface configured to increase the friction fit between an accessory and the first jaw 104 when compared to a generally smooth surface. For example, the first jaw 104 includes a ridged surface 118 coupled directly to the inner surface 116. The ridged surface 118 may be comprised of a malleable and/or compressible material (e.g., rubber, silicone, foam, elastomer). In other embodiments, the ridged surface 118 is comprised of a generally rigid material. In some embodiments, the ridged surface 118 is comprised of a material having a Shore A hardness of between about 80 to about 90. In some embodiments, the ridged surface is comprised of a thermoplastic rubber (TPR). In some embodiments, the ridged surfaced 118 is integrally formed with the inner surface 116. In other embodiments, the ridged surface 118 is fixedly coupled to the inner surface 116 via, for example, a fastener and/or adhesive.

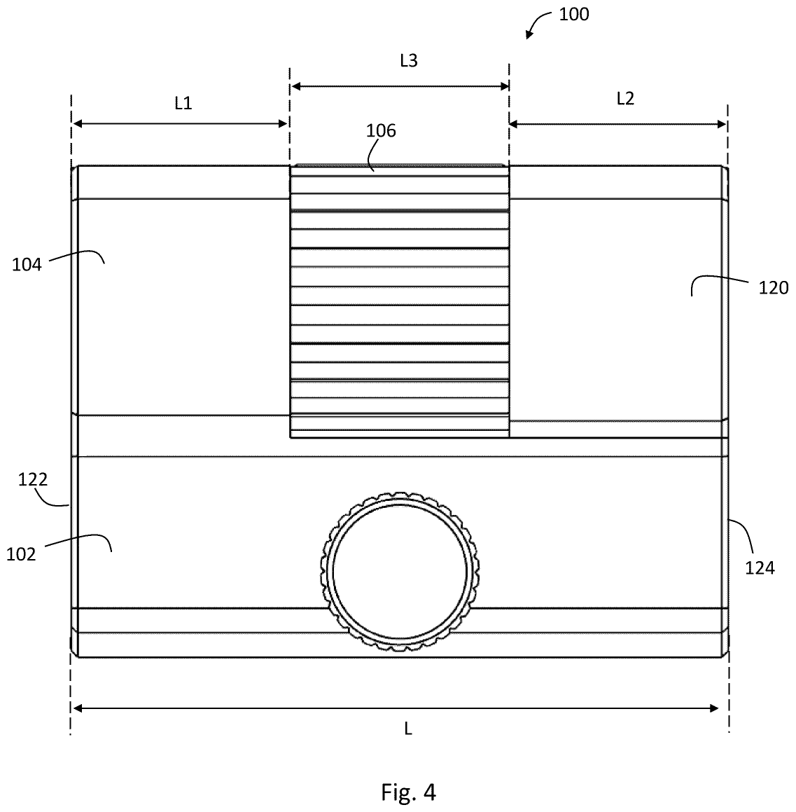

Referring to FIGS. 1 and 4, the clamp 100 may include a second fixed jaw 120 coupled to the frame 102. In some embodiments, the second fixed jaw 120 is substantially the same as the first fixed jaw 104. In some embodiments, for example, the second fixed jaw 120 may have generally the same size and shape as the first fixed jaw 104 and may include a corresponding inner surface defined by the same radius of curvature R. As such, the inner surface of the second fixed jaw 120 may be defined by an arc having the same arc length as that of the inner surface 116 of the first fixed jaw 104. The second fixed jaw 120 may be fixedly coupled to the frame 102 and extend upwardly therefrom in generally the same manner as the first fixed jaw 104. For example, the second fixed jaw 120 may be integrally formed with the frame 102. However, in some instances both the first and second fixed jaws 104, 120 are detachably coupled to the frame 102 such that they may be replaced with different fixed jaws.

In some embodiments, the first and second fixed jaws 104, 120 are spaced from one another in the longitudinal direction. For example, the frame 102 has a length L as measured in a longitudinal direction between opposed left and right sidewalls 122, 124 of the frame 102. In some embodiments, the first and second fixed jaws 104, 120 are positioned on the same side of the frame 102. For example, each of the first and second jaws 104, 120 may be positioned relative to the frame 102 generally at the front surface 154 thereof. The first fixed jaw 104 may extend in the longitudinal direction from the left side wall 122 towards the right sidewall 124 by a length L1. The second fixed jaw 120 may extend in the longitudinal direction from the right sidewall 124 towards the left sidewall 122 by a length L2. In some embodiments, the lengths L1 and L2 are generally equal. The sum of the lengths L1 and L2 may be less than the total length L of the frame 102. For example, the sum of the lengths L1 and L2 may be about one-third of the total length L of the frame 102. As such, the first fixed jaw 104 and second fixed jaw 120 may not directly contact one another. In some embodiments, by providing a space between the first and second fixed jaws 104, 120, the weight of the clamp 100 may be reduced when compared to a single fixed jaw spanning the entire length L of the frame 102. In some embodiments, by positioning the first and second fixed jaws 104, 120 at the left and right sides of the frame 102 the clamp 100 may be configured to provide leverage to an accessory received by the jaws 104, 120 along the entire length L of the frame 102. For example, the outer edges of each jaw 104, 120 may abut an accessory providing leverage thereto at locations that are generally planar to the left and right sidewalls 122, 124.

In other embodiments, the clamp 100 includes a single fixed jaw generally the same as the first and/or second fixed jaws 104, 120. For example, there may be a single fixed jaw having generally the same shape and/or size as either of the jaws 104, 120 coupled to the frame 102 and extending upwardly from the top surface 108 thereof. In one embodiment, the single fixed jaw has a length as measured in the longitudinal direction generally equal to the length L of the frame 102. For example, the single fixed jaw may extend along the top surface 108 from the left sidewall 122 to the right sidewall 124. In another embodiment, the single fixed jaw has a length greater than or generally equal to the length L1 and/or the length L2. For example, the single fixed jaw may extend along the top surface 108 between the left sidewall 122 and right sidewall 124 by a length generally equal to L1. In such instances, the single fixed jaw may be positioned relative to the frame 102 such that it at least partially overlaps the second jaw 106 in the longitudinal direction. For example, the single fixed jaw and the adjustable second jaw 106 may be aligned with one another in the longitudinal direction.

In some embodiments, the first fixed jaw 104, second fixed jaw 120 and the adjustable second jaw 106 are arranged along the top surface 108 of the frame 102 forming a generally serpentine or staggered pattern. For example, the first fixed jaw 104, second fixed jaw 120 and the adjustable second jaw 106 may be arranged along the top surface 108 at different longitudinal positions. In some embodiments, the first fixed jaw 104, second fixed jaw 120, and the adjustable jaw 106 do not overlap one another in the longitudinal direction. For example, and as best illustrated in FIG. 4, the adjustable jaw 106 extends between the first fixed jaw 104 toward the second fixed jaw 120 in the longitudinal direction by a length L3. The first fixed jaw 104 and second fixed jaw 120 may be spaced from one another in the longitudinal direction by the length L3. The sum total of the lengths L1, L2 and L3 may be generally equal to the total length L of the frame 102. As such, there may be substantially no overlap in each of the jaws 104, 106, 120 with regards to the longitudinal direction. Each of the lengths L1, L2 and L3 may be substantially equal to one another. For example, each of the lengths L1, L2, and L3 may be generally equal to about one-third of the total length L of the frame 102. In some embodiments, arranging the jaws 104, 106, 120 in the staggered pattern may reduce the overall weight of the clamp 100, when compared to providing a single fixed jaw and/or adjustable jaw that spans the length L of the frame 102.

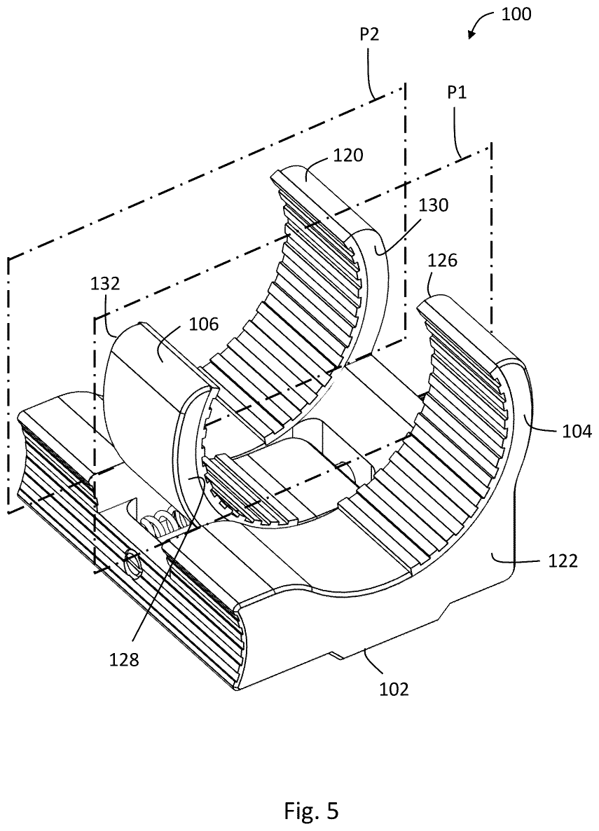

Referring to FIGS. 4-5, in some embodiments, one or more of the jaws 104, 106, 120 may include a generally planar side surface positioned within a shared imaginary plane. For example, the first fixed jaw 104 includes a right-side surface 126 and the adjustable jaw 106 includes a left-side surface 128 each of which is positioned within a first imaginary plane P1. The second fixed jaw 104 may include a left-side surface 130 and the adjustable jaw 106 may include a right-side surface 132 each of which being positioned within a second imaginary plane P2. In some embodiments, each of the side surfaces of the jaws 104, 106 and 120 are offset from the imaginary planes P1 and P2 by a clearance distance (e.g., between about 0.003 inches to about 0.011 inches). In some embodiments, the side surfaces 126, 128, 130, and 132 extend along the respective imaginary planes P1, P2 but do not extend therethrough. For example, the adjustable jaw 106 may be positioned entirely between the first and second imaginary planes P1, P2. In other embodiments, at least one of the jaws 104, 106 and 120 extends at least partially through at least one of the imaginary planes P1, P2. For example, the adjustable jaw 106 may extend through both the imaginary planes P1 and P2 such that it at least partially overlaps the first fixed jaw 104 and second fixed jaw 120 in the longitudinal direction.

Referring to FIG. 3, in some embodiments, the second jaw 106 has a shape that is generally the same as the first jaw 104 and positioned relative to the base in a mirrored orientation. For example, the second jaw 106 includes an inner surface 134 defined by a radius of curvature R and faces towards the inner surface 116 of the first jaw 104. In some embodiments, the inner surface 134 of the second jaw 106 forms an arc defined by an arc length. The arc length of the inner surface 134 may be generally the same as the arc length of the inner surface 116. In some instances, the second jaw 106 adjustable relative to the frame 102 such that the inner surfaces 116 and 134 may each be disposed about a common central axis C and may form an arc. For example, the second jaw 106 may be positioned relative to the first jaw 104 such that the respective axes that the inner surfaces extend partially around are parallel and overlap one another such that the inner surfaces 116 and 134 define a continuous arc.

In some embodiments, the second jaw 106 includes a ridged surface 119 configured to increase the friction fit between an accessory and the second jaw 106 when compared to a generally smooth surface. In one embodiment, the ridged surface 119 is integrally formed with the second jaw 106. In other embodiments, the ridged surface 119 is coupled to the inner surface 134 of the second jaw 106 via one or more fasteners and/or adhesives. The ridged surface 119 may be comprised of the same material as the ridged surface 118 (e.g., rubber, a synthetic rubber, silicone, etc.). In some embodiments, the first and second jaws 104, 106 may define an opening at the top of the clamp 100 for receiving an accessory. For example, each of the first jaw 104 and second jaw 106 extend upwardly from the top surface 108 of the frame 102 and terminate at respective ends 136, 138 that are spaced from one another. In some embodiments, the clamp 100 is configured to prevent the ends 136, 138 from contacting one another. For example, the maximum travel distance of the second jaw 106 towards the first jaw 104 may be insufficient to cause the ends 136, 138 to overlap one another in a lateral direction.

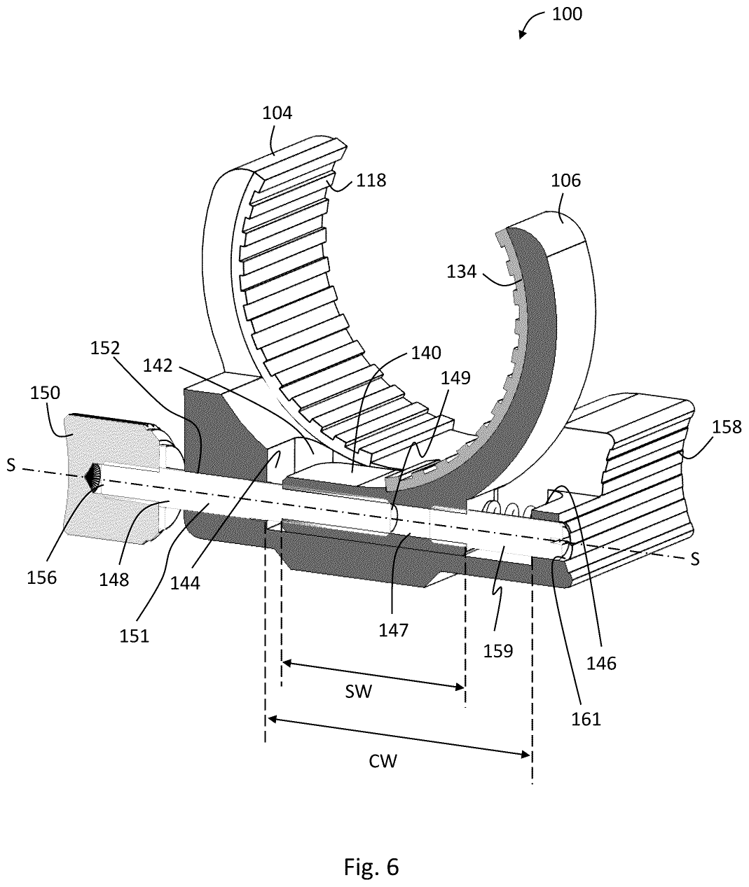

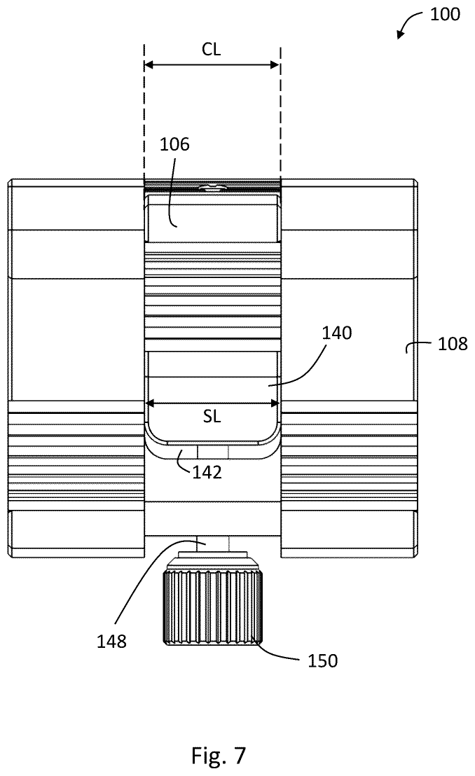

Referring to FIGS. 6-7, the adjustable second jaw 106 is configured to enable an accessory to be received and secured by the clamp. The second jaw 106 may be coupled to the frame 102 opposite the first jaw 104 and extend upwardly from the top surface 108 away from the bottom surface 110. The second jaw 106 may be slidable relative to the frame 102 and first jaw 104 between an open position and a closed position. In the open position, accessories may be coupled to or decoupled from the clamp 100. For example, in the open position there may be a sufficient amount of space between the first and second jaws 104, 106 such that an accessory may be placed therebetween or removed therefrom as desired. In the closed position, the second jaw 106 may exert a pressure on the accessory causing the accessory to be secured to the clamp 100 between first jaw 104 and second jaw 106. For example, in the closed position the first and second jaws 104, 106 may each abut the accessory and the second jaw 106 may apply a pressure thereto to cause the accessory to be secured to the clamp 100.

The second jaw 106 may be coupled to a slide 140 that is configured to enable the second jaw 106 to translate relative to the frame 102. The slide 140 may be fixedly coupled to the second jaw 106 such that translation of the slide 140 in a direction causes the second jaw 106 to translate in the same direction with the slide 140. In some embodiments, the slide 140 is integrally formed with the second jaw 106. In other embodiments, the slide 140 is detachably coupled to the second jaw 106. The slide 140 may be configured to be received within a channel 142 of the frame 102 that at least partially defines the path along which the second jaw 106 may translate. For example, the slide 140 may be retained between adjacent sidewalls of the channel 142 thereby constraining movement and/or rotation of the slide 140 relative to the channel 142. In some embodiments, the slide 140 is generally limited to one degree of motion (e.g., a linear movement) when received within the channel 142. For example, the sidewalls and/or bottom surface of the channel 142 at least partially prevent the slide 140 from being rotated about lateral and/or longitudinal axis and generally prevent the slide 140 from translating in the longitudinal direction while enabling translation in the lateral direction.

The channel 142 may have a longitudinal length CL and lateral width CW that are greater than the longitudinal length SL and lateral width SW of the slide 140. In some embodiments, the longitudinal length CL of the channel 142 is sufficient to allow the slide 140 to translate along the channel 142 in the lateral direction. For example, the lengths CL and SL may be such that there is a clearance between the lateral sidewalls of the slide 140 and channel 142 to enable the slide 140 to translate along the channel 142 relative to the base. In some embodiments, the slide 140 and channel 142 are sized to be in slip-fit tolerance with one another. For example, the clearance between the lateral sidewalls of the slide 140 and channel 142 is between about 0.003 inches to about 0.011 inches. As such, the slide 140 may translate along the channel 142 generally without abutting or scraping against the sidewalls of the channel 142.

The width CW of the channel 142 may be greater than the width SW of the slide 140 such that the second jaw 106 may translate between the open and closed positions. For example, the slide 140 is translatable along the channel 142 towards a front sidewall 144 thereof such that the second jaw 106 is moveable towards a closed position. Similarly, the slide 140 may be translatable along the channel 142 towards a rear sidewall 146 thereof such that the second jaw 106 is moveable towards the open position. In some embodiments, the width SW of the slide 140 at least partially defines the maximum possible travel distance of the second jaw 106. For example, the slide 140 may be capable of translating in the lateral direction between the front and rear sidewalls of the channel 142 by a maximum distance generally equal to the width CW of the channel 142 minus the width SW of the slide 140 (e.g., maximum travel distance=CW−SW). Accordingly, in some such embodiments, the maximum travel distance of the second jaw 106 is directly related to the width SW of the slide 140. In the embodiment illustrated in FIG. 6, the width SW of the slide 140 is about 70% of the channel width CW. However, it should be understood that the width SW of the slide 140 and/or width CW of the channel 142 may be altered to achieve a desired maximum possible travel distance.

Referring to FIGS. 1 and 6, in some embodiments, the second jaw 106 is coupled to a stem 148 and stem head 150 configured to adjust the position of the second jaw 106 relative to the frame 102. The stem 148 may be comprised of a metal (e.g., steel, stainless steel) and in some instances may optionally be treated with a corrosion-resistant surface treatment. The stem 148 may extend through a stem aperture 152 in the frame 102 and engage with the second jaw 106. In some embodiments, the stem aperture 152 extends from a front exterior surface 154 of the frame 102 to the channel 142. For example, the stem aperture 152 is open at the front exterior surface 154 of the frame 102 and extends through a thickness thereof to the channel 142. As such, the stem aperture 152 may enable the stem 148 to pass therethrough into the channel 142 and be coupled to the slide 140. In some embodiments, the stem 148 includes a distal receiving segment 149 configured to engage the slide 140 of the second jaw 106. For example, the distal receiving segment 149 may include a threaded outer surface engaged with a corresponding threaded recess or channel 147 of the slide 140. As such, the stem 148 may be threadably coupled to the slide 140 such that the slide 140, and second jaw coupled thereto 106, are translatable with the stem 148.

In some embodiments, the stem 148 and stem head 150 are configured to be translated along a linear axis (e.g., a stem axis S). The stem 148 and/or stem aperture 152 may be generally aligned with the stem axis S. For example, in one embodiment the stem 148 is cylindrical in shape and includes an outer sidewall extending circumferentially the stem axis S. The stem axis S may be generally transverse to the longitudinal direction. For example, the jaws 104, 106 and/or 120 extend partially along the length of the frame in a direction (e.g., the longitudinal direction) that is transverse to the stem axis S. The stem 148 may extend laterally along the stem axis S through the stem aperture 152. The stem aperture 152, in one embodiment, may include an inner sidewall that extends circumferentially around the stem axis S. The inner sidewall of the stem aperture 152 may be sized to allow the stem 148 to pass therethrough and may be generally smooth to allow for the stem 148 to be slid along the inner sidewall. In some embodiments, stem aperture 152 is not threaded such that stem 148 may pass therethrough in a linear movement along the stem axis S without the need for rotating stem 148 relative to stem aperture 152. In some embodiments, the portion of stem 148 that is positioned within stem aperture 152 may also be generally smooth and lack screw threads. In some embodiments, the stem 148 and stem apertures 152 are sized to be slip-fit to one another. For example, the inner sidewall may have a diameter that is greater than the diameter of the stem 148 by between about 0.003 inches to about 0.011 inches.

In some embodiments, the stem 148 couples the stem head 150 to the second jaw 106. The stem 148 may include a proximal receiving segment 156 exterior to the channel 142 and positioned opposite the distal receiving segment 149. The proximal receiving segment 156 may be configured to couple the stem head 150 thereto. For example, the proximal receiving segment 156 may include a threaded outer surface configured to engage with a corresponding threaded channel in the stem head 150 to couple the stem head 150 thereto. In other embodiments, the stem head 150 is integrally formed with the stem 148. In some embodiments, the stem 148 includes an intermediary segment 157 that is configured to enable the stem 148 to slide along the stem aperture 152 in the frame 102. The intermediary segment 157 may extend between the proximal receiving segment 156 and distal receiving segment 149 and be generally smooth to allow for translation through the stem aperture 152 without rotation of the stem 148. For example, the intermediary segment 157 may include a non-threaded outer surface that extends circumferentially around the stem axis S at a generally constant radius of curvature between the proximal and distal receiving segments 156, 149.

The stem head 150 may be coupled to the stem 148 such that it is exterior to the frame 102. As such the stem head 150 may be easily accessible to user for selectively adjusting the position of the second jaw 106. The stem head 150 may be fixed in position relative to the stem 148 such that translation of the stem head 150 along the stem axis S causes the stem 148 to translate in the same direction. For example, a user may press the stem head 150 towards the frame 102, which causes the stem 148 and second jaw 106 coupled thereto to translate along the stem axis S towards the back surface 158 of the frame 102. In this manner, the stem head 150 may enable users to quickly and easily transition the second jaw 106 from a closed position to an open position using a single hand.

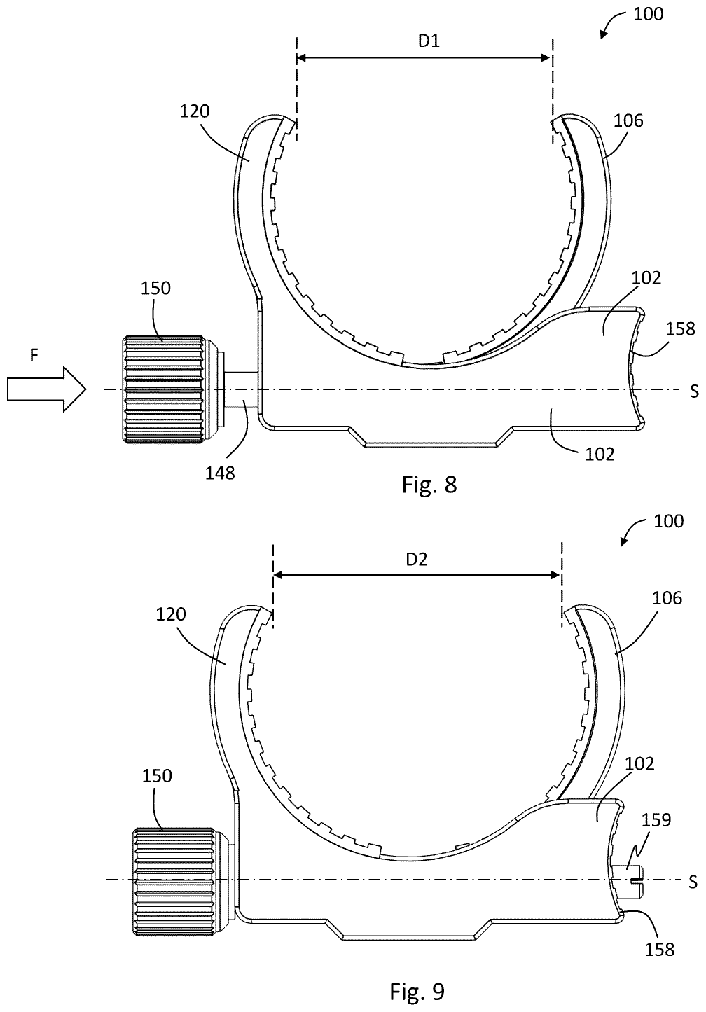

Further to this example, there is shown in FIGS. 8-9 an example of the adjustable second jaw 106 translating relative to the frame 102 in response to a force applied on the stem head 150. In FIG. 8, the clamp 100 is in a closed position such that the adjustable second jaw 106 and the second fixed jaw 120 are spaced from one another by a distance D1 as measured in the lateral direction. In FIG. 8 a force F is applied to the stem head 150 thereby causing the stem head 150 to translate along the stem axis S towards the frame 102. The stem 148 translates with the stem head 150 along the stem axis S through the stem aperture 152 (shown in FIG. 6) in the frame 102. The translation of the stem 148, in turn, causes the second jaw 106 to translate relative to the frame 102 along the stem axis S in the same direction. For example, and as shown in FIG. 9, the second jaw 106 is translated along the stem axis S away from the second fixed jaw 120 from the closed position to an open position. In the in the open position illustrated in FIG. 9, the second jaw 106 is spaced from the second fixed jaw 120 in the lateral direction by a distance D2 that is greater than the distance D1. As such, the clamp 100 of the present disclosure may be configured to enable a user to transition the clamp 100 from the closed position (e.g., as shown in FIG. 8) to the open position (e.g., as shown in FIG. 9) by simply depressing the stem head 150 towards frame 102 with the use of a single hand.

The frame 102 may be sized and/or shaped to fit easily within a user's hand. For example, the footprint of the frame 102 may be sized to allow the frame 102 to be gripped by a user with a single hand. The rear surface 158 of the frame 102 may be shaped and/or include surfaces configured to enable a user to easily maintain a grip of the clamp 100 while depressing the stem head 150. For example, the rear surface 158 may be generally concave in shape and optionally include a ridged gripping surface. A user may grip the frame 102 by placing their fingertips on the rear surface 158 and actuating the stem head 150 with their thumb, for example. The stem head 150 may include an indented outer surface within which a user's thumb may rest. As such, the shape and placement of the rear surface 158 relative to the stem head 150 and the shape of the stem head 150 may enable the clamp 100 to be operated by a user without the need for excessive gripping force or pressure and while allowing the user's hand to avoid potentially awkward and uncomfortable joint positions and motions. In some embodiments, the concave shape of the rear surface 158 may increase the stability of the clamp 100 when the user is holding the clamp 100 and/or depressing the stem head 150.

Although the first jaw 104 is not shown in FIGS. 8-9, it should be understood that the relative motions and distances described above with respect to the second jaw 106 and second fixed jaw 120 may generally apply to motions and distances with respect to the second jaw 106 and the first fixed jaw 104.

Referring to FIGS. 6 and 9, the clamp 100 may include a pin 159 configured to retain the orientation of second jaw 106 relative to the channel 142 during translation of the second jaw 106 relative to the frame 102. The pin 159 may be coupled to the slide 140 and frame 102 opposite the stem 148. For example, the pin 159 may extend along the stem axis S between the rear surface 158 of the frame 102 and the slide 140. In some embodiments, the pin 159 is fixed in position relative to the slide 140. For example, the pin 159 may include a threaded segment engaged with the threaded channel 147 of the slide 140. In some embodiments, the pin 159 is translatable relative to the frame 102 with the second jaw 106.

The pin 159 may extend through a pin aperture 161 in the rear surface 158 of the frame 102 and is slidable therethrough. For example, and as illustrated in FIG. 9, the pin 159 translates with the slide 140 generally along the stem axis S through the pin aperture 161 and extends outwardly from the rear surface 158 of the frame 102. In some embodiments, the pin 159 is detachable from the slide 140 such that the second jaw 106 may be removed from the clamp 100. For example, the pin 159 is configured to be disengaged from the threaded channel 147 to enable a user to remove the slide 140 and second jaw 106 from the channel 142. In some embodiments, the clamp 100 includes more than one pin generally the same as the pin 159 and engaged with the second jaw 106. The pin 159 may be comprised of a generally rigid material (e.g., steel, cast iron). In some embodiments, the pin 159 has a width as measured in the lateral direction sufficient to prevent an unintended disengagement with the pin aperture 161 at the rear surface 158 of the housing 100.

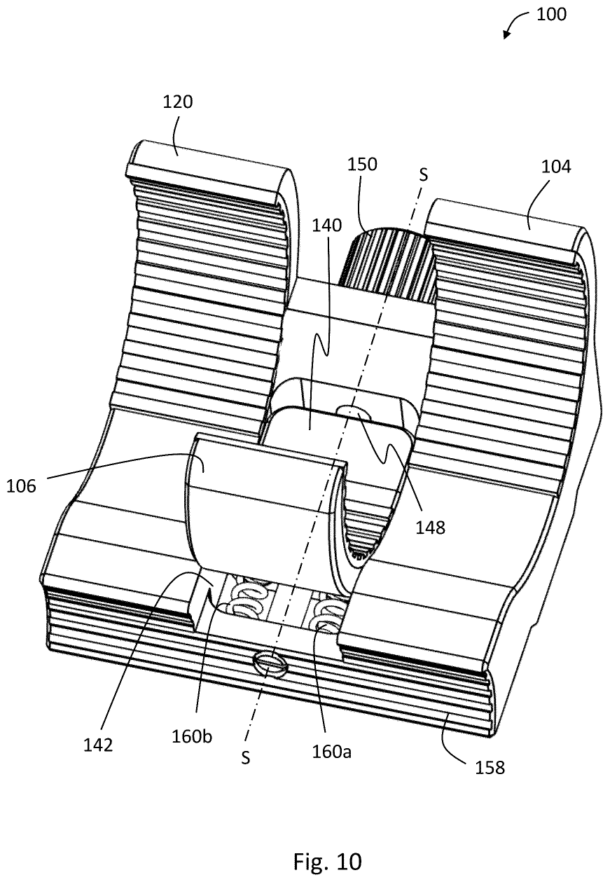

Referring to FIG. 10, the clamp 100 may include one or more biasing elements configured to bias the second jaw 106 towards the closed position. For example, the clamp 100 may include a first biasing element 160a and a second biasing element 160b coupled to the second jaw 106 and biasing the second jaw 106 toward the first jaw 104. Each of the biasing elements 160a, 160b may be coupled to the second jaw 106 and to the frame 102. For example, the biasing elements 160a, 160b may abut the slide 140 and the rear sidewall of the channel 142 of the frame 102. In some embodiments, the biasing elements 160a, 160b are positioned relative to the second jaw 106 such that a force exerted thereon causes the second jaw 106 to be biased towards the first jaw 104. For example, the biasing elements 160a are positioned relative to the second jaw 106 opposite the stem head 150 and stem 148.

The biasing elements 160a, 160b may be oriented relative to the second jaw 106 such that a force exerted thereon by the biasing elements 160a, 160b is in a direction generally parallel to the stem axis S. For example, the biasing elements 160a, 160b may be coiled helical springs (e.g., compression springs) extending around respective spring axes that are generally parallel to the stem axis S. In this manner, when compressed, the biasing elements 160a, 160b may exert a force on the slide 140 in a direction generally parallel to the stem axis S. For example, in response to a user pressing the stem head 150 inward towards the rear exterior wall 158 of the frame 102, each of the biasing elements 160a, 160b may be compressed.

When compressed, the force exerted on the slide 140 via the biasing elements 160a, 160b causes the second jaw 106 to be biased towards the first and/or second fixed jaws 104, 120. In response to the user ceasing to press the stem head 150 inward, the force of the biasing elements 160a, 160b automatically causes the second jaw 106 to translate from an open position (as shown in FIG. 9) along the stem axis S and return to the closed position (as shown in FIG. 8). As such, the biasing elements 160a, 160b may enable the clamp 100 to automatically transition to or towards the closed position from an open position without requiring manual input from a user. In some embodiments, the biasing elements 160a, 160b helps to maintain clamp 100 in the closed positioned to hold the accessory (e.g., light source) in place between the first and second jaws 104, 106 during use. In some embodiments, a user must exert a force on stem head 150 greater than and opposite to the biasing force of the biasing elements 160a, 160b in order to cause second jaw 106 to move towards the open position.

In the embodiment shown in FIG. 10, the clamp 100 includes two compression spring type biasing elements 160a, 160b extending along respective spring axes (not illustrated) that are offset from and generally parallel to the stem axis S. However, in other embodiments, the clamp 100 may include any number and/or type of biasing elements configured to cause the second jaw 106 to be biased towards the closed position. For example, in one embodiment, the clamp 100 includes a single biasing element generally the same as either of the biasing elements 160a, 160b except that it extends generally around the stem axis S. It should also be understood that the biasing elements 160a, 160b may at least partially restrict the maximum possible travel distance of the second jaw 106 relative to the frame 102. For example, the compression spring biasing elements 160a, 160b have a predetermined maximum spring compression corresponding to the distance with which each spring may travel without any permanent deformation caused by fatigue or stress. Accordingly, the maximum spring compression may in some instances cause the maximum possible travel distance of the second jaw 106 to be less than the difference of the channel width CW and slide width SW, as discussed above with reference to FIG. 6. However, in some embodiments, the slide 140 and/or frame 102 may include recessed surfaces for receiving the biasing elements 160a, 160b to enable the maximum possible travel distance to be generally equal to the difference of the channel width CW and slide width SW.

Referring to FIGS. 6 and 11-13, the stem head 150 may be configured to limit the maximum travel distance of the second jaw 106 relative to the frame 102. The position of the stem head 150 relative to the frame 102 may be adjustable independent of the second jaw 106. In some embodiments, the stem head 150 is configured to be rotated, generally about the stem axis S, to cause the stem head 150 to translate relative to the frame 102 towards or away from the front surface 154 thereof. For example, and as described above, in some embodiments the distal receiving segment 149 of the stem 148 is coupled to the slide 140 via a threaded engagement with the threaded channel 147 thereof. The slide 140 may be rotatably fixed to the frame 102 and/or channel 142 such that rotation of the stem 148 does not cause the slide 140 to rotate about the stem axis S. As such, the threaded engagement between the distal receiving segment 149 and threaded channel 147 may cause the stem 148, and stem head 150 coupled thereto, to translate along the stem axis S when stem head and stem 148 are rotated about stem axis S while the slide 140 and the second jaw 106 connected thereto remain fixed in position relative to the frame 102.

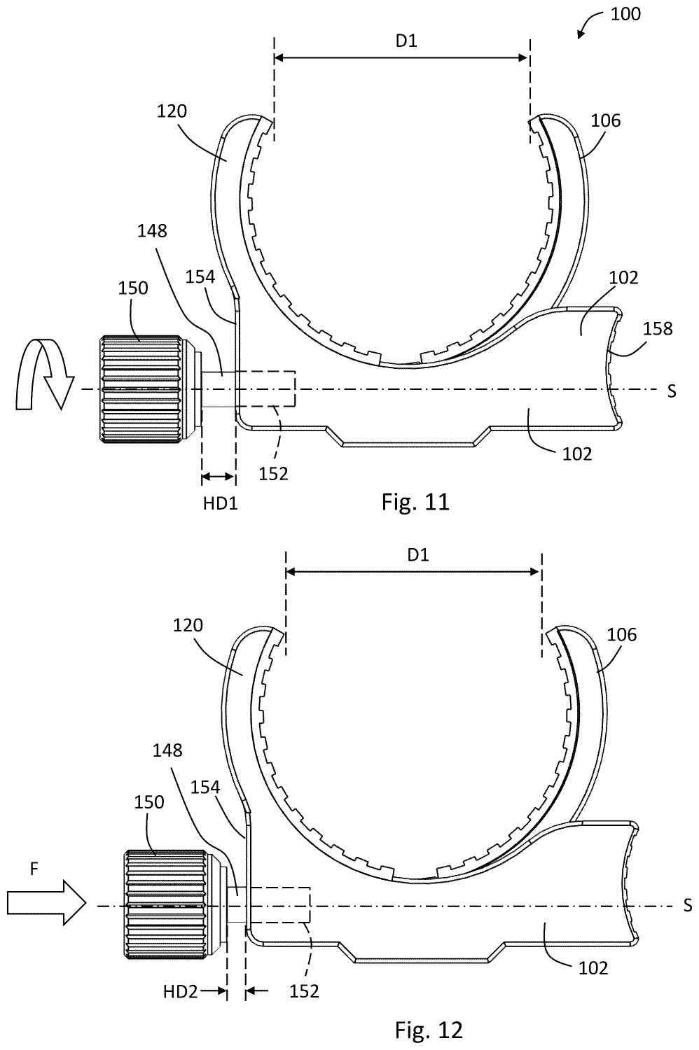

The stem head 150 is rotatable about the stem axis S in a first direction (e.g., a clockwise direction) to cause the stem head 150 to translate along the stem axis S towards the second jaw 106. For example, in FIG. 11 the second jaw 106 is in the closed position in which the second jaw 106 and second fixed jaw 120 are spaced from one another by the distance D1. A rear surface of the stem head 150 in FIG. 11 is spaced from the front surface 154 of the frame 102 by a distance HD1. A clockwise torsional force is applied to the stem head 150 causing the stem head 150 to rotate in the clockwise direction. The engagement between the stem 148 and slide 140 causes the stem head 150 to translate along the stem axis S towards the front surface 154 of frame 102 and/or the second jaw 106. For example, in FIG. 12 the stem head 150 translates along the stem axis S such that rear surface thereof is spaced from the front surface 154 of the frame by a distance HD2, which is less than the distance HD1.

As illustrated in FIG. 12, the rotation of the stem head 150 causes the head 150 to translate relative to the frame 102 without causing the second jaw 106 to translate with the stem head 150. For example, the second jaw 106 is spaced from the second fixed jaw 120 by the same distance D1 before and after rotation and translation of the stem head 150 whereas the distance between the stem head 150 and frame 102 is reduced from HD1 to HD2. As such, the clamp 100 of the present disclosure is configured to enable a user to adjust the position of stem 150 relative to the frame 102, second jaw 106 and/or slide 140.

In some embodiments, the position of the stem head 150 relative to the frame 102, second jaw 106 and/or slide 140 at least partially defines the maximum travel distance of the second jaw 106. In some embodiments, the stem head 150 is configured to abut the frame 102 rather than extend therethrough as it translates along the stem axis S. The stem aperture 152 may be sized to prevent the stem head 150 from passing therethrough such that the stem head 150 may translate along the stem axis S towards the frame 102 until stem head 150 abuts the front surface 154 thereof. For example, the stem head 150 may have a dimension (e.g., a diameter) that is greater than the diameter of the stem aperture 152 thereby preventing the stem head 150 from being translatable through the stem aperture 152. As such, the maximum travel distance of the stem head 150 along the stem axis S is defined by the distance, as measured in the lateral direction, between rear-most facing surface of the stem head 150 and the front surface 154 of the frame 102. For example, in FIG. 11, the maximum travel distance of the stem head 150 is generally equal to HD1 and in FIG. 12, the maximum travel distance is generally equal to HD2.

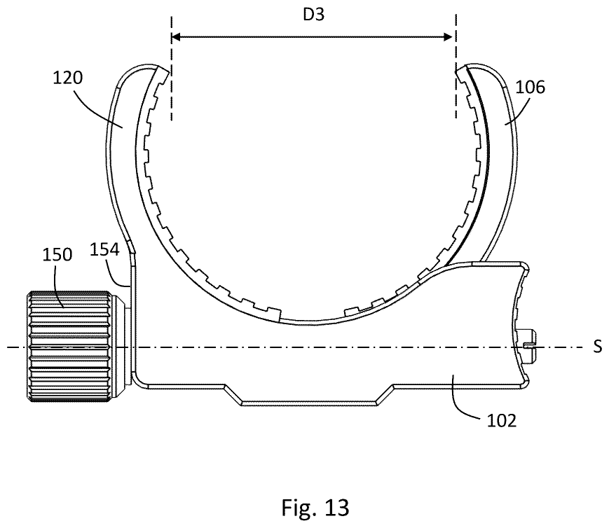

As discussed above, the second jaw 106 is translatable with the stem head 150. As such, in an instance where the maximum travel distance of the stem head 150 is less than the maximum possible travel distance of the second jaw 106, translation of the second jaw 106 may be limited to the maximum travel distance of the stem head 150. For example, in FIG. 12, a force F is exerted on the stem head 150 to cause it to translate along the stem axis S towards the front surface 154 of the frame 102. The stem head 150 translates along the stem axis S until it abuts the front surface 154 of the frame 102 as illustrated in FIG. 13. The translation of the stem head 150 along the stem axis S causes the second jaw 106 to translate away from the second fixed jaw 120. For example, in FIG. 13, the second jaw 106 is spaced from the second fixed jaw 120 by a distance D3 which is greater than the distance D1. The difference between the distanced D3 and D1 may be generally equal to the distance HD2 between the stem head 150 and frame 102 prior to the translation of the stem head 150.

By providing a steam head 150 capable of being adjusted relative to the frame 102 the clamp 100 of the present disclosure may enable users to selectively tighten or loosen the grip of the jaws 104, 106, 120 on an accessory and/or prevent unintentional decoupling of the accessory from the clamp 100. For example, rotation of the stem head 150 about the stem axis S while the stem head 150 abuts the frame 102 may increase or decrease the pressure that the second jaw 106 exerts on an accessory based on the direction of rotation. Rotation of the stem head 150 about the stem axis S while the stem head 150 does not abut the frame 102 may reduce the maximum travel distance of the second jaw 106 such that it is not capable of being opened to a distance sufficient for an accessory to be removed therefrom. In some embodiments, reducing the maximum travel distance of the second jaw 106 via the stem head 150 increases the safety of the clamp 100 by preventing accidental decoupling of the accessory therefrom.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order.

What is claimed is:

1. A clamp comprising:
a frame;
a first jaw coupled to the frame and fixed in position relative to the frame;
a second jaw coupled to the frame opposite the first jaw and slidable relative to the frame;
a stem extending at least partially through a stem aperture in the frame and engaged with the second jaw, the stem translatable relative to the frame along a stem axis and rotatable about the stem axis;
a stem head coupled to the stem, the stem aperture being sized to prevent the stem head from passing entirely therethrough; and
a biasing element biasing the second jaw towards the first jaw,
wherein the second jaw is capable of translating relative to the frame along the stem axis in response to translation of the stem without rotating about the stem axis.

2. The clamp of claim 1, wherein the first jaw and second jaw each include inner surfaces facing towards one another and having generally the same radius of curvature.

3. The clamp of claim 2, wherein the first jaw and second jaw when in a closed position form an arc.

4. The clamp of claim 2, wherein the first jaw and second jaw extend upwardly from the frame and terminate at ends that are spaced from one another.

5. The clamp of claim 3, wherein when in the closed position the ends of each of the first jaw and second jar do not directly contact one another.

6. The clamp of claim 1, wherein the first jaw and second jaw each extends at least partially along a length of the frame in a direction transverse to the stem axis.

7. The clamp of claim 1, wherein translation of the stem head along the stem axis towards the stem aperture causes the biasing element to compress.

8. The clamp of claim 7, wherein rotation of the stem head about the stem axis does not cause the biasing element to compress.

9. The clamp of claim 1, wherein the first jaw is a first fixed jaw and the second jaw is an adjustable jaw, the clamp further includes, a second fixed jaw coupled to the frame and fixed in position relative to the frame, the second fixed jaw being positioned opposite the adjustable jaw on the same side of the frame as the first fixed jaw.

10. The clamp of claim 9, wherein the first fixed jaw, the adjustable jaw, and the second fixed jaw are positioned along a top surface of the frame and arranged in a serpentine pattern.

11. The clamp of claim 1 further comprising:
a pin coupled to the second jaw and extending through a pin aperture of the frame, the pin aperture extending through a side surface of the frame opposite the stem aperture, the pin being translatable along the pin aperture in a direction generally parallel to the stem axis.

12. The clamp of claim 1, wherein the second jaw has a maximum travel distance defined at least partially by the stem head and rotation of the stem about the stem axis causes the maximum travel distance of the second jaw to be altered.

13. The clamp of claim 1, wherein the stem head is connected to the stem at a proximal receiving segment thereof and the stem is connected to the second jaw at a distal receiving segment thereof.

14. The clamp of claim 13, wherein the stem is at least partially threaded and is threadably coupled to the second jaw.

15. The clamp of claim 14, wherein the distal receiving segment of the stem is threaded and the stem further includes a non-threaded intermediary segment between the proximal and distal receiving segments that is slidable along the stem aperture.

16. The clamp of claim 1, wherein the frame includes a channel constraining movement of the second jaw relative to the frame in at least one direction.

17. The clamp of claim 1, wherein the stem head is a knob having an outer diameter greater than an outer diameter of the stem aperture.

18. A clamp comprising:
a frame;
a first jaw fixedly coupled to the frame;
a second jaw adjustably coupled to the frame, the second jaw being slidable toward or away from the first jaw along a linear axis;
a stem extending along the linear axis and through an aperture in the frame, the stem attached to the second jaw at a distal portion and attached to a stem head at a proximal portion, a distance between the stem head and second jaw capable of being adjusted to limit travel of the second jaw along the linear axis; and
a biasing element biasing the second jaw towards the first jaw,
wherein movement of the stem head along the linear axis causes the second jaw to translate along the linear axis with the stem head and wherein rotation of the stem head about the linear axis causes a distance between the stem head and second jaw to be adjusted.

19. The clamp of claim 18, wherein the second jaw capable of translating relative to the frame along the stem axis without rotating about the stem axis.

20. A clamp comprising:
a frame having a top surface and a channel open at the top surface and extending partially toward a bottom surface of the frame, the frame including a stem aperture extending from a side surface of the frame to the channel;
a first jaw fixedly coupled to the frame and extending upwardly from the top surface thereof;
a second jaw coupled to a slide received within the channel, the second jaw extending outwardly from the top surface of the frame, the second jaw slidable relative to the first jaw along a linear axis;
a biasing element engaged with the slide and biasing the second jaw towards the first jaw in a direction generally parallel to the linear axis; and
a stem extending through the stem aperture along the linear axis and having a threaded distal portion engaged with the slide and a proximal portion attached to a knob,
wherein movement of the knob along the linear axis causes the second jaw to translate along the linear axis with the knob and wherein rotation of the knob about the linear axis causes a distance between the knob and second jaw to be adjusted, and
wherein the second jaw is capable of translating relative to the frame along the stem axis without rotating about the stem axis.
